(19) United States
(12) Patent Application Publication
(10) Pub. No.: US 2004/0123488 A1
(43) Pub. Date: Jul. 1, 2004

(54) Base structure for air inflow in clothes dryer

(75) Inventor: In Hee Han, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 10/660,731

(22) Filed: Sep. 12, 2003

(30) Foreign Application Priority Data
Sep. 12, 2002 (KR) P2002-00055459

(51) Int. Cl. F26B 11/02

(52) U.S. Cl. 34/595

(57) ABSTRACT

The present invention relates to a clothes dryer, in which a base structure is improved for increasing an air flow rate introduced into the gas combustion device for improving a combustion efficiency and a cooling characteristics of components as well as reducing production of hazardous gas. For this, the present invention provides base structure in a clothes dryer, including a plurality of air holes 100 in a base ‘B’ in a front area of an inlet side of a mixing pipe, which clothes dryer has the base ‘B’ forming a bottom, a front cabinet ‘FC’ forming a front face, a side cabinet ‘SC’ forming a side, a back cover ‘BC’ forming a rear face, a top cover ‘TC’ mounted both on top of the front cabinet ‘FC’ and the side cabinet ‘SC’, screw type legs ‘L’ at respective corners of the base ‘B’, a mixing pipe 24 on the base ‘B’ forming a bottom for mixing gas sprayed from the gas nozzle 22 and primary air, a guide funnel 20 mounted on an outlet side of the mixing pipe 24, a gas nozzle 22 mounted opposite to the inlet of the mixing pipe 24, a valve 30 connected to the gas nozzle 22 for gas supply and control of the gas supply rate, and an igniter 26 in a fore end of the mixing pipe 24 for igniting a mixture gas.

This application claims the benefit of Korean Application(s) No. P2002-0055459 filed on Sep. 12, 2002, which is/are hereby incorporated by reference.

### BACKGROUND OF THE INVENTION

1. Field of the Invention

The present invention relates to clothes dryers, and more particularly, to a base structure which can increase a flow rate of air introduced into a drying drum.

2. Discussion of the Related Art

FIG. 1 illustrates a perspective view showing an exterior of exemplary clothes dryer, wherein in general a body of the clothes dryer is provided with a base ‘B’ forming a bottom, a front cabinet FC forming a front face, a side cabinet SC forming a side, a back cover BC forming a rear face, and a top cover TC mounted on top of the front cabinet FC and the side cabinet SC.

There is a control panel CP in a rear part of the top cover TC.

Moreover, the front cabinet FC of the body of the clothes dryer is provided with an introduction opening for introduction/ taking out of laundry, and a door ‘D’ for selective opening/closing of the introduction opening.

Together with this, there are screw type legs ‘L’ at respective corners of the base ‘B’ for adjusting a height of the body.

In the meantime, FIG. 2 illustrates a disassembled perspective view showing an inside of a related art clothes dryer. As shown, there is the drying drum 1 mounted in the body of the clothes dryer to be rotatable upon receiving a driving force from the motor. The drying drum 1 is cylindrical, with opened front and rear parts, and a belt groove 2 in a middle part of an outside circumference for winding a belt (not shown) driving by a separate driving source thereon.

The drying drum 1 is provided with a drying chamber 5 therein for carrying out drying, and a plurality of lifters 6 on an inside thereof for lifting and dropping a drying object in the drying chamber 5 to upside down the drying object to improve a drying efficiency.

The drying drum 1 has a front supporter 7 and a rear supporter 9 at opposite front and rear ends thereof. The front supporter 7 and the rear supporter 9 close a front side and a rear side of the drying drum 1, to form a drying chamber 5, and support the front end and the rear end of the drying drum 1.

There are sealing members 10 between the front supporter 7 and the rotatable drying drum 1, and between the rear supporter 9 and the rotatable drying drum 1, for prevention of leakage. Of course, the front supporter 7 and the rear supporter 9 are provided with a plurality of rollers (not shown) at relevant positions of the front and rear parts of the drying drum 1 for supporting the drying drum 1.

In the meantime, the front supporter 7 has a through hole 8 for making the drying chamber 5 and an outside of the drying chamber 5 in communication. The through hole 8 is opened/closed with a door (not shown) selectively.

The rear supporter 9 has an inlet duct 12 mounted thereto in communication with the drying chamber 5 for serving as a passage of the hot air to be supplied to the drying chamber 5.

The front supporter 7 has an outlet assembly 13, which is a part for escaping of the air from the drying chamber 5, at one side thereof at a lower end of the through hole 8. The outlet assembly 13 has a lint filter 14.

The lint filter 14 filters foreign matters (for an example, threads, or dust) from air escaping the drying chamber 5.

In the meantime, there is a lint duct 15 in communication with the outlet assembly 13. The lint filter 14 is positioned even inside of the lint duct 15. There is a blower 17 connected to the lint duct 15 for drawing air from the drying chamber 5 through the line duct 15. The blower 17 is mounted in a blower housing 18.

The blower housing 18 has one side in communication with the lint duct 15, and the other side connected to an air discharge pipe 19. Therefore, the air escaped from the drying chamber 5 and passed through the lint duct 15 is discharged to an outside of the dryer through the discharge pipe 19 by a blowing action of the blower 17.

In the meantime, there is a guide funnel 20 connected to an inlet side of the inlet duct 12. The guide funnel 20 guides hot air produced by combustion of gas to the inlet side of the inlet duct.

There is a mixing pipe 24 on an inlet side of the guide funnel 20 for mixing gas sprayed from a gas nozzle 22 and primary air.

An outlet of the mixing pipe 24 is positioned in a state spaced a distance inward from the inlet of the guide funnel 20.

The gas nozzle 22 is positioned opposite to the inlet of the mixing pipe 24, and has a valve 30 for controlling supply and a supply rate of the gas.

The valve 30 has a gas pipeline 23 connected thereto for continuous supply of the gas from a separate gas supply source.

According to this, the gas sprayed from the gas nozzle 22 and the external air introduced thereto through the inlet of the mixing pipe, i.e., primary air, are mixed in the mixing pipe 24.

There is an igniter 26 in a fore end of the mixing pipe 24 for igniting the mixing gas.

The operation of the related art clothes dryer will be described.

Upon introducing drying objects (for an example, laundry) into the drying chamber 5 in the drying drum 1, closing the door, and pressing an operation button, the drying drum 1 rotates as the belt wound in the belt groove 2 is driven by a separate driving source.

When the blower 17 is driven, air is drawn from the drying chamber 5 through the lint duct 15. In such as case, external air is introduced into the drying chamber 5 through the inlet duct 12 owing to a pressure difference.

In this instance, the air supplied to the inlet duct 12 is heated with a gas combustion device to a relative high temperature before introduction thereto.

That is, as the gas is sprayed into the mixing pipe 24 from the gas nozzle 22, and the primary air introduced into the inlet of the mixing pipe 24 through fin like suction louvers in one area of the back cover BC, and the gas and the air are mixed to each other in the mixing pipe 24, and ignited with the igniter 26 initially at the outlet of the mixing pipe 24, is the mixture gas burns.

In the meantime, there is secondary air introduced to a flame produced as the mixture gas burns at the outlet of the mixing pipe 24, to produce hot air as a thermal energy generated when the gas burns heats the air introduced into an inside of the guide funnel 20.

The hot air is introduced into the drying chamber 5 in the drying drum 1 through the inlet duct 12, for carrying out drying operation.

In the meantime, the hot air having moisture absorbed from the laundry in the drying chamber 5 escapes the drying chamber 5 through the outlet assembly 13. The escape of the air through the outlet assembly 13 is made by a suction force of the blower 17. In this instance, dust and thread are filtered from the air escaping the outlet assembly 13 at the lint filter 14.

Then, the air passed through the lint filter 14 is discharged to the outside of the dryer through an outlet opening 120e in the back cover BC via the discharge pipe 19 by the blowing of the blower 17.

However, the related art clothes dryer has the following problems.

Since the air is drawn only through the fin like suction louvers 120a in one area of the back cover BC, the air flow rate can not be increased anymore.

In this case, the combustion efficiency drops, and flames have poor characteristics, or much hazardous gas is produced.

Particularly, in the related art, the flow rate of the primary air into the mixing pipe 24 is liable to be short, as the air is introduced through the suction louver 120a in the back cover BC opposite to the inlet of the mixing pipe 24.

Moreover, in the related art, there has been a problem in that the shortage of the air flow rate into the system causes excessive heating of components of the system.

Furthermore, the shortage of the air flow rate causes excessive high temperature of the hot air introduced into the drying drum 1, resulting in damage to the clothes.

For reference, FIG. 4 illustrates a front part of the related art base, with which it can be known that there is no air introduction structure in the related art base.

### SUMMARY OF THE INVENTION

An object of the present invention, devised to solve the related art problem, lies on providing an improved base structure for increasing an air flow rate introduced into the gas combustion device to improve a combustion efficiency and a cooling characteristics of components as well as reduce production of hazardous gas.

To achieve the object of the present invention, there is provided a base structure in a clothes dryer including a plurality of air holes in a base in a front area of an inlet side of a mixing pipe; the clothes dryer having a base forming a bottom, a front cabinet forming a front face, a side cabinet forming a side, a back cover forming a rear face, a top cover mounted both on top of the front cabinet and the side cabinet, screw type legs ‘L’ at respective corners of the base, a mixing pipe on the base forming a bottom for mixing gas sprayed from the gas nozzle and primary air, a guide funnel mounted on an outlet side of the mixing pipe, a gas nozzle mounted opposite to the inlet of the mixing pipe, a valve connected to the gas nozzle for gas supply and control of the gas supply rate, and an igniter in a fore end of the mixing pipe for igniting a mixture gas.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a perspective view showing an exterior of exemplary clothes dryer.

FIG. 2 illustrates a disassembled perspective view showing an inside of a related art clothes dryer.

FIG. 3 illustrates a side section showing key parts in the related art.

FIG. 4 illustrates a plan view of a front part of the base in FIG. 3.

FIG. 5 illustrates a side section showing key parts of the present invention.

FIG. 6 illustrates a plan view of a front part of the base in FIG. 5.

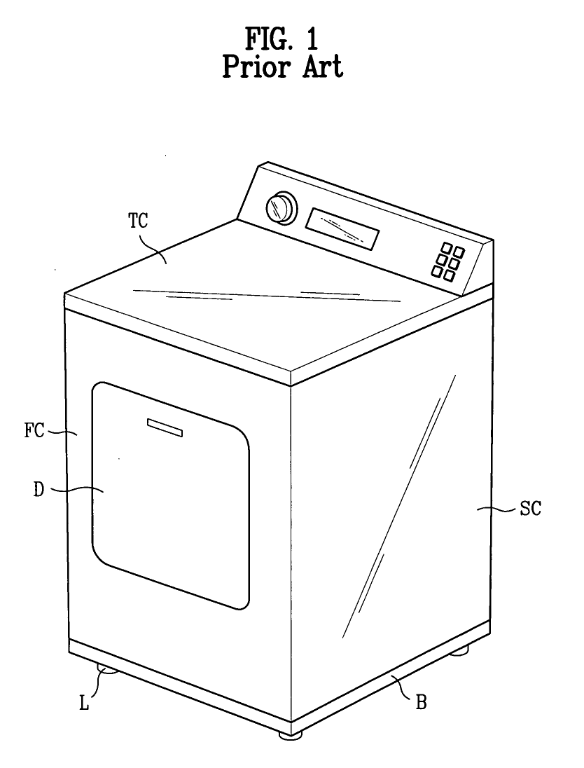

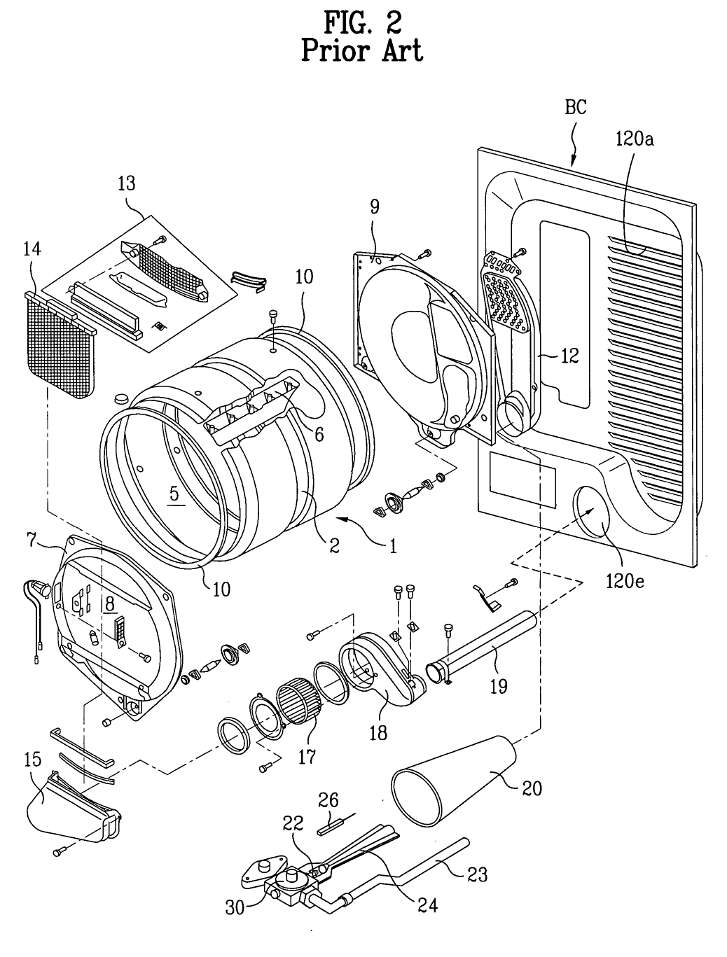

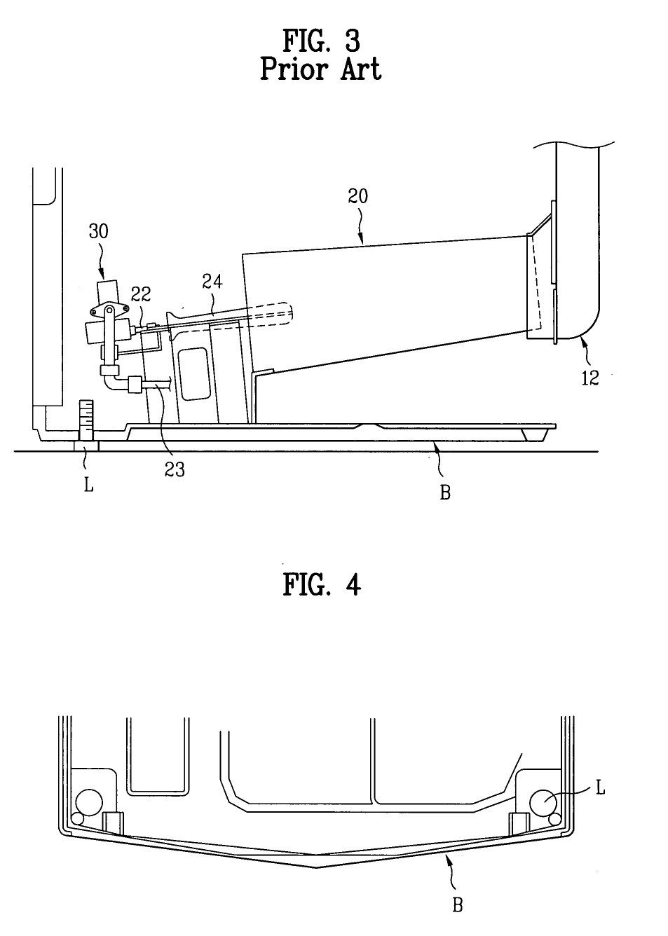

### DETAILED DESCRIPTION OF THE PREFERRED EMBODIMENT(S)

Reference will now be made in detail to the preferred embodiment(s) of the present invention, examples of which are illustrated in the accompanying drawings. Throughout the drawings, like elements are indicated using the same or similar reference designations where possible.

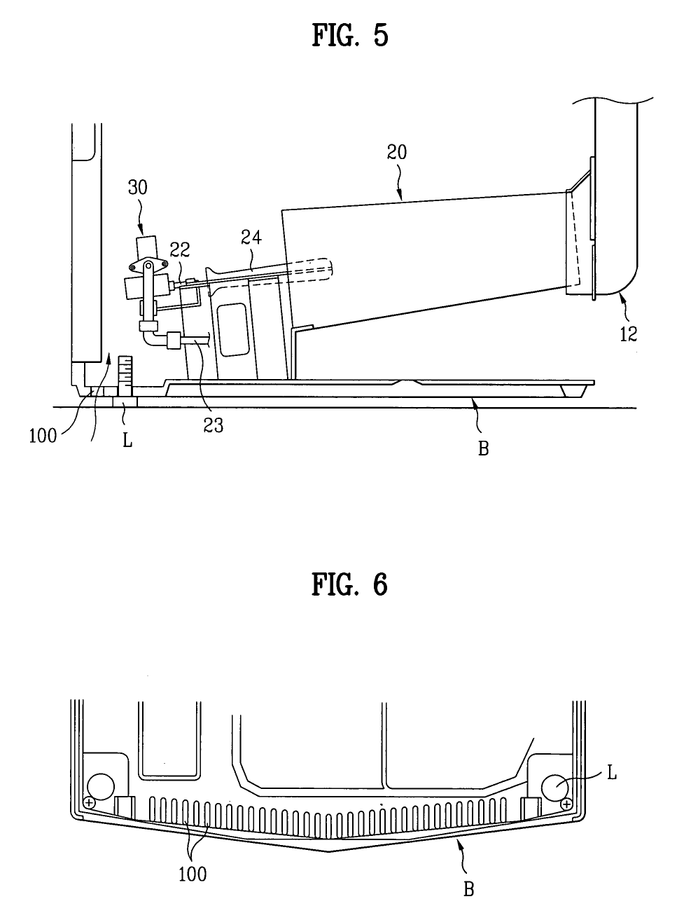

An embodiment of the present invention will be described in detail with reference to the attached drawings FIGS. 4 and 5.

FIG. 5 illustrates a side section showing key parts of the present invention, and FIG. 6 illustrates a plan view of a front part of the base in FIG. 5, wherein a base structure in a clothes dryer includes a plurality of air holes 100 in a base ‘B’ in a front area of an inlet side of a mixing pipe, which clothes dryer has the base ‘B’ forming a bottom, a front cabinet ‘FC’ forming a front face, a side cabinet ‘SC’ forming a side, a back cover ‘BC’ forming a rear face, a top cover ‘TC’ mounted both on top of the front cabinet ‘FC’ and the side cabinet ‘SC’, screw type legs ‘L’ at respective corners of the base ‘B’, a mixing pipe 24 on the base ‘B’ forming a bottom for mixing gas sprayed from the gas nozzle 22 and primary air, a guide funnel 20 mounted on an outlet side of the mixing pipe 24, a gas nozzle 22 mounted opposite to the inlet of the mixing pipe 24, a valve 30 connected to the gas nozzle 22 for gas supply and control of the gas supply rate, and an igniter 26 in a fore end of the mixing pipe 24 for igniting a mixture gas.

The air holes 100 are formed at regular intervals along left and right directions of the base ‘B’.

Moreover, each of the air holes 100 has a form of a long hole in a front/rear direction of the base ‘B’.

The operation of the present invention will be described.

The clothes dryer of the present invention has air for burning gas for drying operation, introduced, not only through the fin like suction louvers 120a in one side area of the back cover BC, but also through the plurality of air holes 100 in the base in the front area of the inlet side of the mixing pipe.

That is, as shown in FIG. 5, since the base ‘B’ is spaced from a floor with the legs ‘L’, the external air can be introduced through the air holes 100 in the base ‘B’ via a gap between the base ‘B’ and the floor.

Accordingly, different from the related art, the clothes dryer of the present invention can secure an adequate flow rate, to enhance a combustion efficiency, improve flame characteristics, and reduce generation of hazardous gas.

Particularly, different from the related art in which the air is introduced only through the suction louvers 120a in the back cover BC opposite to the inlet side of the mixing pipe 24, as the air is introduced from the front area of the inlet side of the mixing pipe 24, the problem of the related art is solved, in which the flow rate of the primary air to be introduced into the inlet of the mixing pipe 24 is liable to be short.

Along with this, since the flow rate of the external air introduced into an inside of the system increases in the present invention, an effective cooling of the components of the system can be made, and the problem of clothes damage caused by excessive high temperature of the hot air introduced into the drying drum coming from shortage of the air flow rate is also solved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

That is, though the air hole 100 has a form of a long hole in the foregoing embodiment, the form is not limited thereto, but there may be a variety of forms of the air holes.

Accordingly, the present invention has the following advantages or effects.

As has been described, the present invention is related to a clothes dryer, in which a base structure is improved for increasing a flow rate of air introduced into a gas combustion device.

Accordingly, the present invention has effects of improving a combustion efficiency and cooling characteristics of components, and reducing production of hazardous gas, as well as preventing clothes from being damaged by excessive temperature rise of the hot air introduced into the drying drum.

What is claimed is:

1. A base structure in a clothes dryer comprising;
a plurality of air holes in a base in a front area of an inlet side of a mixing pipe, the clothes dryer having a base forming a bottom, a front cabinet forming a front face, a side cabinet forming a side, a back cover forming a rear face, a top cover mounted both on top of the front cabinet and the side cabinet, screw type legs ‘L’ at respective corners of the base, a mixing pipe on the base forming a bottom for mixing gas sprayed from the gas nozzle and primary air, a guide funnel mounted on an outlet side of the mixing pipe, a gas nozzle mounted opposite to the inlet of the mixing pipe, a valve connected to the gas nozzle for gas supply and control of the gas supply rate, and an igniter in a fore end of the mixing pipe for igniting a mixture gas.

2. The base structure as claimed in claim 1, wherein the plurality of air holes are formed at regular intervals along left/right directions of the base.

3. The base structure as claimed in claim 1 or 2, wherein each of the air holes is formed in a long hole form having a length in a front/rear direction of the base.
